(19) United States
(12) Patent Application Publication
(10) Pub. No.: US 2025/0320950 A1
(43) Pub. Date: Oct. 16, 2025

(54) SELF-HEALING SLEEVES

(71) Applicant: Torc Robotics, Inc., Blacksburg, VA (US)

(72) Inventors: Akshay Pai Raikar, Blacksburg, VA (US); Joseph R. Fox-Rabinovitz, Blacksburg, VA (US)

(21) Appl. No.: 18/634,526

(22) Filed: Apr. 12, 2024

(51) Int. Cl. F16L 57/06

(52) U.S. Cl. CPC F16L 57/06

(57) ABSTRACT

A self-healing sleeve system for protecting a hose includes an outer sleeve surrounding and spaced a distance from the hose and defining an annular cavity between an outer surface of the hose and an inner surface of the outer sleeve and a solidifying compound contained within the annular cavity. When the outer sleeve is breached the solidifying compound is exposed to ambient air.

### TECHNICAL FIELD

The field of the disclosure relates generally to self-healing sleeves and, more specifically, self-healing sleeves for protecting a hose.

### BACKGROUND OF THE INVENTION

Freight trucks may connect the cab to the trailer through various electrical and air hose connection lines to facilitate electrical connection and for supplying compressed air to a braking system during driving operations. These connection lines are critical to operation and are susceptible to damage through excessive strain or cutting by malicious actors. If the connection lines are not fixed or addressed properly, this may result in a failure of the semi-truck operations, which is especially dangerous during driving. Air hose connection line failure is particularly dangerous for autonomous vehicles as it is unlikely that immediate intervention can be taken, for example, there may not be a driver or passenger which can immediately repair or replace the air hose connection line, resulting in a loss of brake pressure.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed self-healing sleeve system for protecting a hose includes an outer sleeve surrounding and spaced a distance from the hose and defining an annular cavity between an outer surface of the hose and an inner surface of the outer sleeve and a solidifying compound contained within the annular cavity. When the outer sleeve is breached the solidifying compound is exposed to ambient air.

In another aspect, the disclosed self-healing sleeve system includes a hose including an outer surface, an outer sleeve surrounding and spaced a distance from the hose and defining an annular cavity between an outer surface of the hose and an inner surface of the outer sleeve, and a solidifying compound contained within the annular cavity. When the outer sleeve is breached the solidifying compound is exposed to ambient air.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an exploded view of an example self-healing sleeve for protecting a hose;

FIG. 2 is a cross-sectional view of the example self-healing sleeve shown in FIG. 1;

FIG. 3 is another cross-sectional view of the example self-healing sleeve shown in FIG. 2 showing a breach in the self-healing sleeve and the hose;

FIG. 4 is another cross-sectional view of the example self-healing sleeve shown in FIG. 2 showing a solidifying compound solidified into a callus to block the breach;

FIG. 5 is another cross-sectional view of the example self-healing sleeve shown in FIG. 4 showing the solidifying compound solidified into the callus to block the breach;

FIG. 6 is an exploded view of another example self-healing sleeve for protecting a hose;

FIG. 7 is a cross-sectional view of the example self-healing sleeve shown in FIG. 6;

FIG. 8 is an exploded view of another example self-healing sleeve for protecting a hose;

FIG. 9 is a cross-sectional view of the example self-healing sleeve shown in FIG. 8; and

FIG. 10 is a cross-sectional view of the example self-healing sleeve shown in FIG. 8 showing a first and second callus formed across a cut end.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

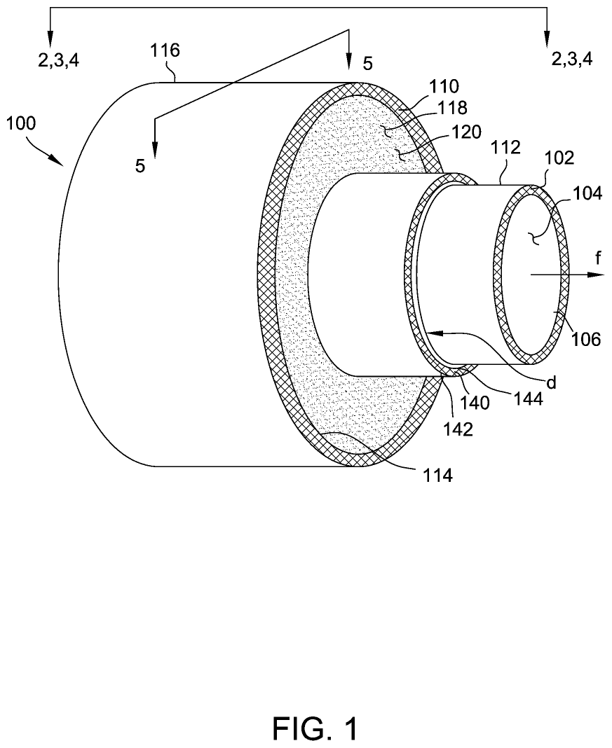

FIG. 1 is a perspective view of an example embodiment of a self-healing sleeve assembly 100 for protecting or repairing a hose 102, such as an air hose or any other type of hose 102 for carrying a fluid f within an inner cavity 104 defined by an inner wall 106 of the hose 102.

The self-healing sleeve assembly 100 includes an outer sleeve 110 circumferentially surrounding an outer surface 112 of the hose 102. The outer sleeve 110 includes an inner surface 114 that faces the outer surface of the hose 102 and an outer surface 116 that may be exposed to the surrounding ambient air. The inner surface 114 of the outer sleeve 110 is spaced a distance D₁ from the outer surface 112 of the hose 102 forming an annular cavity 118 surrounding the outer surface 112 of the hose 102. The sleeve assembly further includes a solidifying compound 120 contained within the annular cavity 118. The solidifying compound 120 may be in liquid or a non-solid form, e.g., having a paste, or gel like consistency, when contained within the annular cavity 118 and shielded from exposure to the ambient air by the outer sleeve 110.

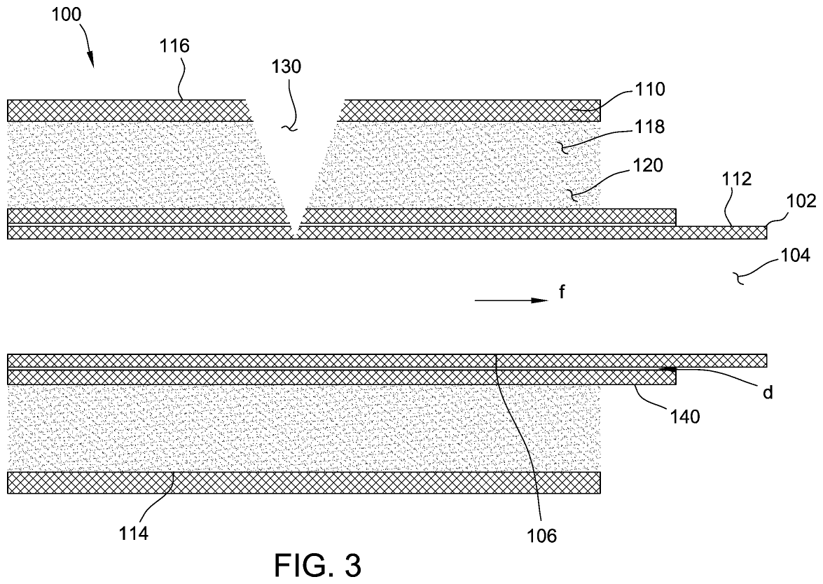

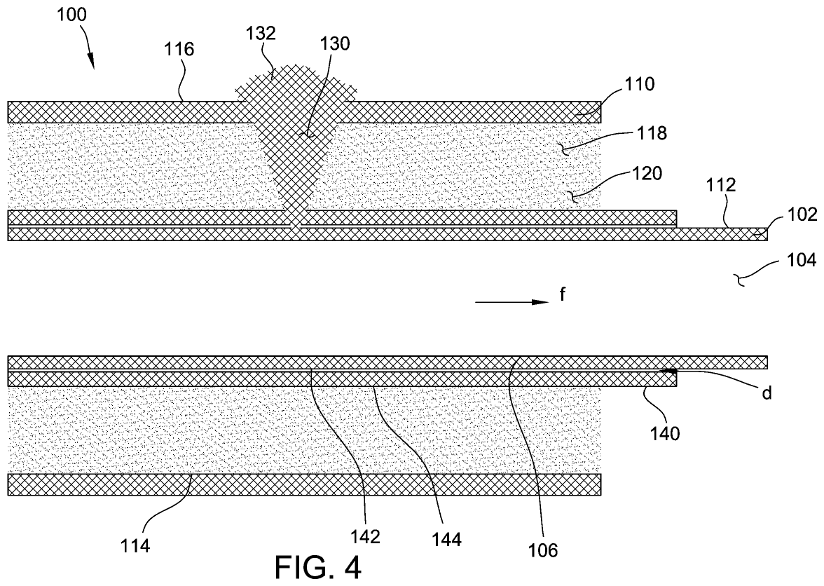

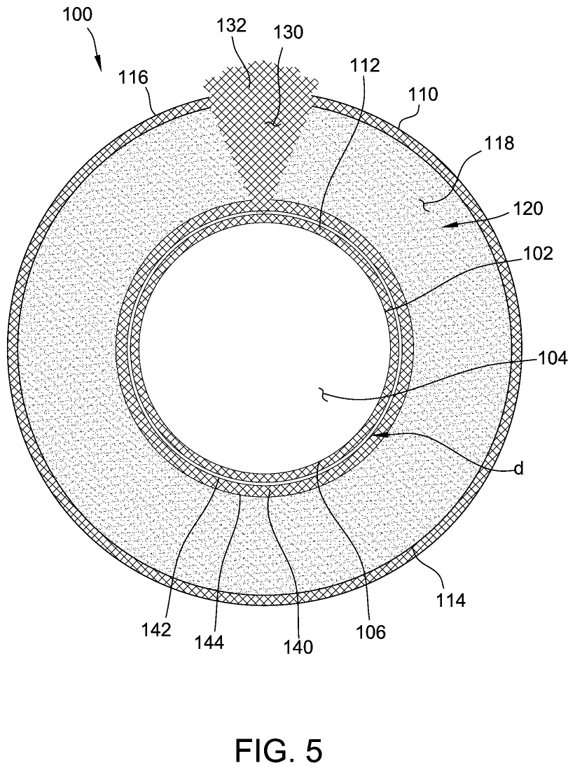

In reference to FIGS. 3-5, when, or if, the outer sleeve 110 is breached forming an opening 130 through the outer sleeve 110, at least a portion of the solidifying compound 120 may be exposed to the ambient air causing the solidifying compound 120 to solidify or harden to form a callus 132 that substantially blocks the opening 130. In some cases, the solidifying compound 120 expands while solidifying causing some of the solidifying compound 120 to extrude through the opening 130 to further block the opening 130, such that a portion of the callus 132 is positioned outside of the outer sleeve 110.

The solidifying compound 120 may include one or more of the following materials; polymeric olefins, polyurethane, polypropylene, or polyethylene, poly viny nitrile, and/or air curing foams or liquids, for example. The solidifying compound 120 may be any other suitable compound that will solidify to form a callus when exposed to air.

In some embodiments, the outer sleeve 110 may be composed of any suitable material such as, for example and without limitation, polyethylene, polyurethane, polyvinyl chloride (PVC), polypropylene, or any suitable rubber or plastic substance.

In some embodiments, the self-healing sleeve assembly includes a protective sleeve 140 positioned between the outer surface 112 of the hose 102 and the solidifying compound 120. The protective sleeve 140 includes an inner surface 142 facing the outer surface 112 of the hose 102 and an outer surface 144 facing or contacting the solidifying compound 120. In some alternative embodiments, the protective sleeve 140 may be omitted. For example, the self-healing sleeve assembly 100 may be adapted for use with different types of hoses 102 composed of various materials and the protective sleeve 140 may be selectively used for hoses 102 having materials that may react with the solidifying compound 120. For example, if the selected solidifying compound 120 may erode the material of the hose 102, the protective sleeve 140 may be selectively used to form a boundary between the hose 102 and the solidifying compound 120. In some embodiments, the protective sleeve 140 may be in direct contact with the outer surface of the hose 102, without any intermediary material positioned therebetween. In some embodiments, the inner surface 142 of the protective sleeve 140 may be coupled to the outer surface of the hose 102, e.g., using any suitable adhesive material. In some embodiments, there may be a slight gap d between the inner surface 142 of the protective sleeve 140 and the outer surface 112 of the hose 102.

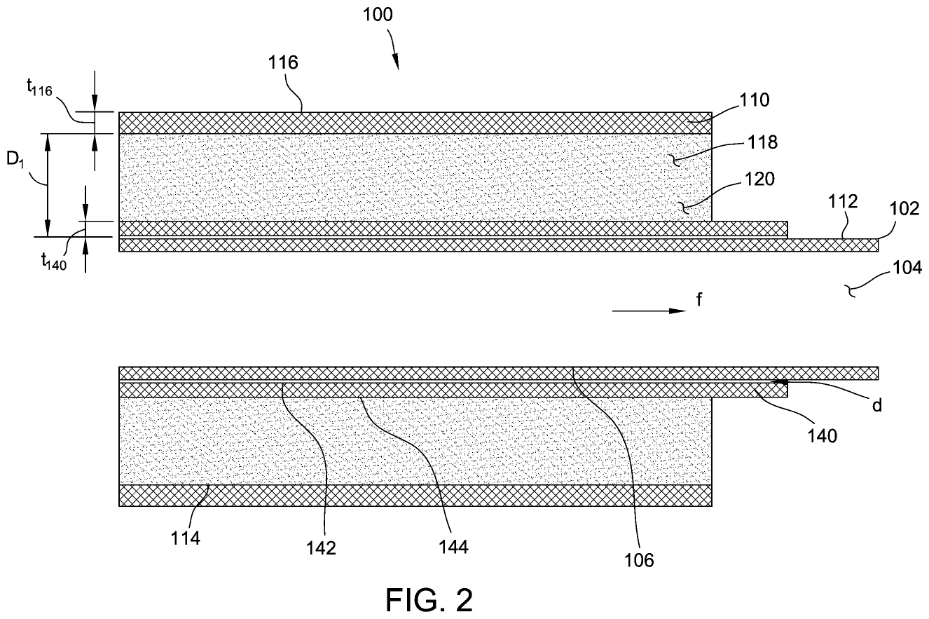

In further reference to FIG. 2, the distance D₁ may be between 15-20 mm, between 20-30 mm, or between 24-40 mm. The outer sleeve 110 has a thickness t₁₁₆ between 2-6 mm, between 4-10 mm, or between 8-12 mm. The protective sleeve 140 has a thickness t₁₄₀ between 1-5 mm, between 2-8 mm, or between 4-10 mm. The outer sleeve 110 may have any suitable thickness t₁₁₆, the protective sleeve 140 may have any suitable thickness t₁₄₀, and the distance D₁ may be any suitable distance that enables the self-healing sleeve assembly 100 to function as described herein.

The protective sleeve 140 may be composed of any suitable material such as, for example and without limitation, polyethylene, polyurethane, polyvinyl chloride (PVC), polypropylene, or any suitable rubber or plastic substance. In some embodiments, the thickness t₁₄₀ of the protective sleeve 140 may be thinner than a thickness of the hose 102. In some embodiments, the protective sleeve 140 may be a sheath including an elongated portion that may be wrapped about the outer surface 112 of the hose 102 in an overlapping helical shape. In some embodiments, the protective layer may be embodied as a coating that may be applied in a non-solid from to the outer surface 112 of the hose 102, and subsequently dried or cured into a protective coating of the hose 102.

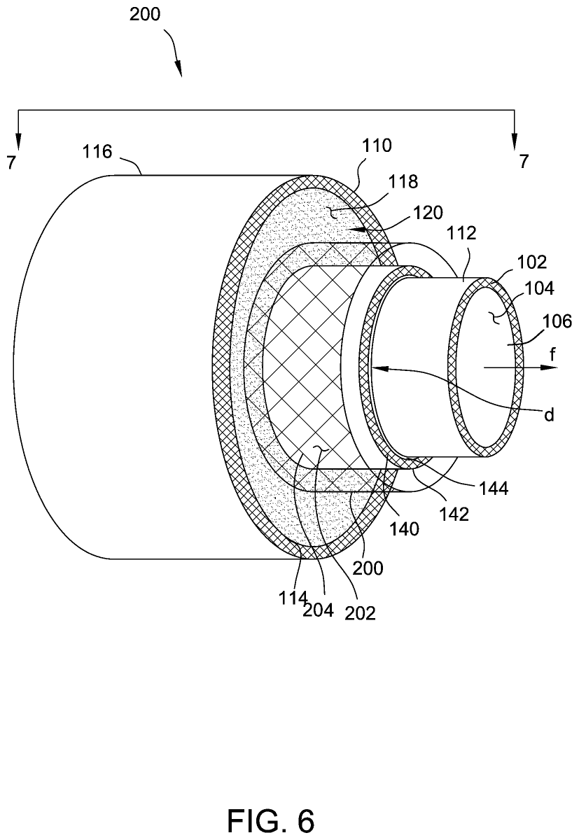

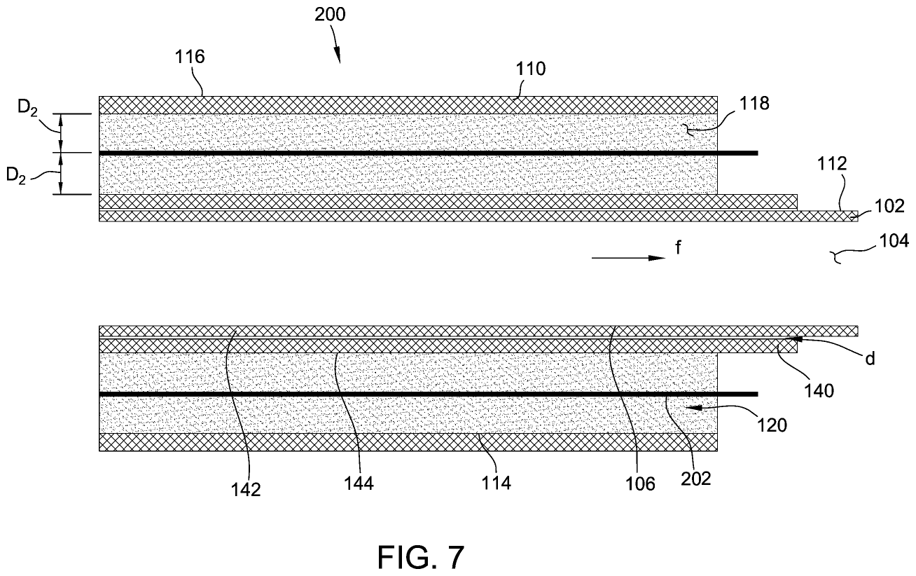

FIGS. 6 and 7 illustrate another example embodiment of a self-healing sleeve assembly 200 for use with the hose 102, including the outer sleeve 110, the protective sleeve 140, the annular cavity 118 and solidifying compound 120. The self-healing sleeve assembly 200 includes a scaffold 202 positioned within the annular cavity 118, embedded in the solidifying compound 120, and surrounding the hose 102. The scaffold 202 provides additional support or rigidity to the solidifying compound 120, either when the solidifying compound 120 is in liquid form or during or after the solidifying compound 120 solidifies. The scaffold 202 may be an open frame 204 defining a plurality of openings 206. The solidifying compound 120 may flow through the openings 206 such that the solidifying compound 120 surrounds the frame 204 of the scaffold 202. In some embodiments, the frame 204 is composed of a wire or braided wire. In some embodiments, the frame 204 is formed of stainless steel, galvanized steel, or aluminum. The frame 204 may be formed of any suitable material, such that the scaffold 202 be able to bend and flex along with bending or flexing of the hose 102 and/or the outer sleeve 110.

The scaffold 202 may be sized or positioned generally centrally within the annular cavity 118, e.g., a distanced D₂ between the inner surface 114 of the outer sleeve 110 and the outer surface 112 of the hose 102 or the outer surface 144 of the protective sleeve 140. In some embodiments, the scaffold 202 may be sized or positioned closer to the hose 102, as compared to the distance between the scaffold 202 and the outer sleeve 110.

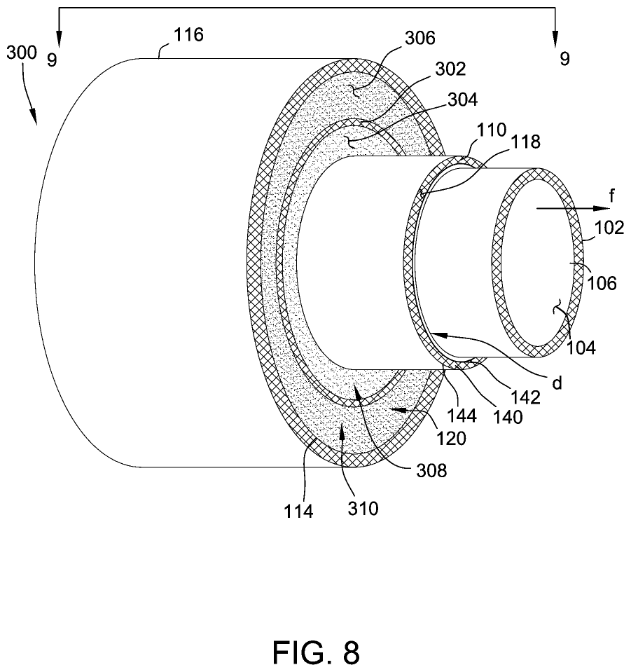

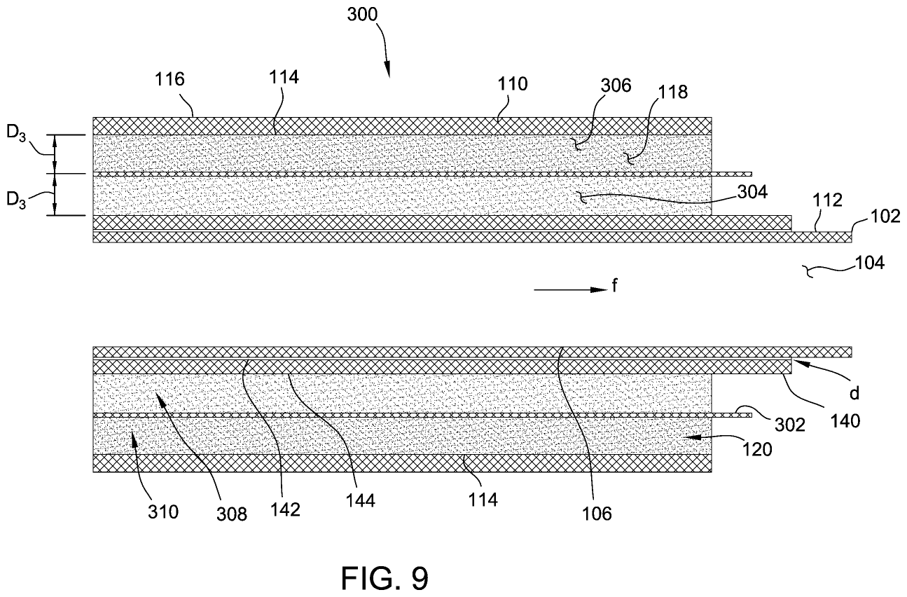

FIGS. 8 and 9 illustrate another example embodiment of a self-healing sleeve assembly 300 for use with the hose 102. The self-healing sleeve assembly 300 may include a separation sleeve 302 that separates the annular cavity 118 into an inner cavity 304 and an outer cavity 306. The solidifying compound 120 includes a first solidifying compound 308, contained within the inner cavity 304, and a second solidifying compound 310 contained within the outer cavity 306. The first and second solidifying compounds 308, 310 may be formed of different compounds having different rates of solidifying. For example, the first solidifying compound 308 may solidify faster than the curing rate of the second solidifying compound 310. In some embodiments, the self-healing sleeve assembly 300 includes a plurality of the solidifying compound 120 that has a curing rate that is dependent on a depth of the breach or opening 130. In some embodiments, the first solidifying compound 308 may have different material properties than that of the second solidifying compound 310. For example, in some embodiments, the second solidifying compound 310 may solidify into a solid that is stronger than the solidified first solidifying compound 308. In some embodiments, the first solidifying compound 308 and the second solidifying compound 310 may be composed of may include one or more of the following materials; polymeric olefins, polyurethane, polypropylene, or polyethylene, poly viny nitrile, and/or air curing foams or liquids, for example. The first solidifying compound 308 and the second solidifying compound 310 may be composed of any other suitable compound that will solidify to form a callus when exposed to air.

In some embodiments, the inner cavity 304 and the outer cavity 306 may have approximately the same thickness, e.g., the separation sleeve 302 is positioned at a halfway distance D₃ between the inner surface 114 of the outer sleeve 110 and the outer surface 112 of the hose 102 or an outer surface 144 of the protective sleeve 140. In some embodiments, the separation sleeve 302 is positioned closer to the hose 102 than to the outer sleeve 110.

In some embodiments, the hose 102 assembly may include the scaffold 202 positioned on either side of the separation sleeve 302. In some alternative embodiments, not shown, the hose 102 assembly includes a first scaffold positioned in the outer cavity 306 and a second scaffold positioned in the inner cavity 304.

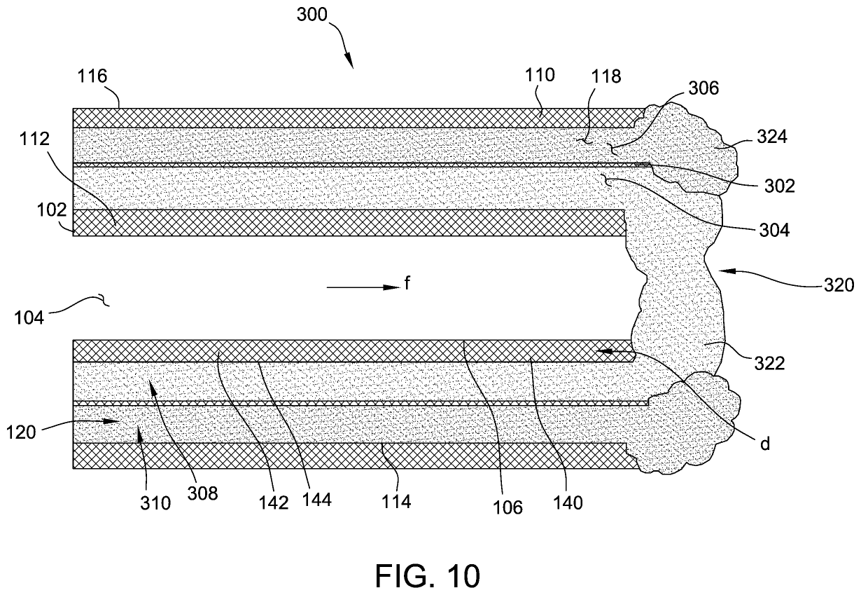

In reference to FIG. 10, in some embodiments, the self-healing sleeve assembly 100, 200, 300 or the hose 102 may be cut completely across the outer sleeve 110 or the hose 102, creating a cut exposed cut end 320. The solidifying compound 120, exposed to the air at the cut end 320, may expand out of the cut end 320 and solidify to substantially block or seal the cut end 320 of the hose 102. The first solidified compound 308 may seal the fluid f contained within the hose 102. The self-healing sleeve assemblies 100, 200, and 300 may be particularly useful for hoses 102 carrying toxic or flammable substances, in the event that the hose 102 is cut or punctured, the solidifying compound 120 will solidify to substantially seal off the hose 102 preventing the substances from leaking out of the hose 102. Furthermore, the self-healing sleeve assembly 300, at an initial time after the self-healing sleeve assembly 300 or the hose 102 have been cut to create the exposed cut end 320, the first solidifying compound 308 starts to expand or solidify creating a first callus 322 in order to rapidly or immediately seal the hose 102. Subsequently, or simultaneously, the second solidifying compound 310 solidifies creating a second callus 324, formed around the first solidifying compound 308 or first callus 322, to further reinforce the first solidifying compound 308 or first callus 322.

In some alternative embodiments, the solidifying compound 120 may include a two-part curing system including a first compound and a second compound that are in non-solid form until the first and second compound are mixed together. For example, the first compound may be separated from the second compound by an intermediate sleeve, e.g., the separation sleeve 302, and when the outer sleeve 110 and the intermediate layer are breached, the first compound may mix with the second compound causing a chemical reaction which solidifies the mixed first and second compounds. For example, in some embodiments, the first compound is disposed between the outer sleeve and the separating sleeve and the second compound is disposed between the separating sleeve and the hose. In some embodiments, the first compound may be contained within a tubular structure that is embedded within the second compound.

Embodiments of the sleeve assembly may be used to protect or seal leakages from any suitable type of hose carrying any kind of fluid therein. For example, in some embodiments, the sleeve assembly may be used with an air hose carrying compressed air. Air hoses may be used in freight trucks for supplying compressed air to air brakes. Frequently, air hoses may be positioned outside of the cab of the freight truck, e.g., the air hose may extend between a compressor positioned in the cab, to the air brake of the trailer. As such, the air hose may be exposed to the elements. In other embodiments, the hose may be a hose for supplying natural gas to a home. Additionally, or alternatively, the hose may be used in, or with, a fuel pump to supply gasoline to a vehicle and, for example, the hose may be a nylon hose. In some embodiments, the hose may be a braided hose composed of nitrile or polytetrafluoroethylene (PTFE) having an inner core with stainless steel, polyester, or nylon braid.

In some embodiments, the hose may be used in the medical field for delivering medical gases for therapeutic purposes. For example, the hose may be composed of medical grade thermoplastic conductive rubber tubing. In some embodiments, the hose may be used in utilities or power applications.

An example technical effect of the methods, systems, and apparatus described herein includes at least one of: (a) protecting a hose from being punctured (b) sealing a breach in the hose; and (c) rapidly sealing a breach in a hose using a first solidifying compound and subsequently reinforcing the first solidifying compound with a second solidifying compound.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A self-healing sleeve system for protecting a hose of a freight truck, the system comprising:
an outer sleeve surrounding and spaced a distance from the hose and defining an annular cavity between an outer surface of the hose and an inner surface of the outer sleeve; and
a solidifying compound contained within the annular cavity, wherein when the outer sleeve is breached the solidifying compound is exposed to ambient air.

2. The system of claim 1, wherein the system further comprises a protective sleeve positioned between the solidifying compound and the outer surface of the hose shielding the hose from the solidifying compound.

3. The system of claim 2, wherein the protective sleeve is coupled to the outer surface of the hose.

4. The system of claim 2, wherein the protective sleeve is coupled to the outer surface of the hose using an adhesive material.

5. The system of claim 1, wherein the system further comprises a scaffold embedded in the solidifying compound between the inner surface of the outer sleeve and the outer surface of the hose.

6. The system of claim 1, wherein the solidifying compound is composed of one or more of the following: polymeric olefins, polyurethane, polypropylene, or polyethylene, poly viny nitrile, and/or air curing foams or liquids.

7. The system of claim 1, wherein the system further comprises a separation sleeve contained between the inner surface of the outer sleeve and the outer surface of the hose, and wherein the solidifying compound includes a first solidifying compound contained between the outer sleeve and the separation sleeve and a second solidifying compound contained between the separation sleeve and the hose.

8. The system of claim 7, wherein the first solidifying compound has a curing rate that is faster than a curing rate of the second solidifying compound.

9. The system of claim 1, wherein the system further comprises a first scaffold and a second scaffold embedded in the solidifying compound between the inner surface of the outer sleeve and the outer surface of the hose.

10. The system of claim 1, wherein the outer sleeve is composed of one or more of polyurethane, polyvinyl chloride (PVC), or polypropylene.

11. A self-healing sleeve system, the system comprising:
a hose of a freight truck, the hose including an outer surface;
an outer sleeve surrounding and spaced a distance from the hose and defining an annular cavity between an outer surface of the hose and an inner surface of the outer sleeve; and
a solidifying compound contained within the annular cavity, wherein when the outer sleeve is breached the solidifying compound is exposed to ambient air.

12. The system of claim 11, wherein the system further comprises a protective sleeve positioned between the solidifying compound and the outer surface of the hose shielding the hose from the solidifying compound.

13. The system of claim 12, wherein the protective sleeve is coupled to the outer surface of the hose.

14. The system of claim 12, wherein the protective sleeve is coupled to the outer surface of the hose using an adhesive material.

15. The system of claim 11, wherein the system further comprises a scaffold embedded in the solidifying compound between the inner surface of the outer sleeve and the outer surface of the hose.

16. The system of claim 11, wherein the solidifying compound is composed of one or more of the following: polymeric olefins, polyurethane, polypropylene, or polyethylene, poly viny nitrile, and/or air curing foams or liquids.

17. The system of claim 11, wherein the system further comprises a separation sleeve contained between the inner surface of the outer sleeve and the outer surface of the hose, and wherein the solidifying compound includes a first solidifying compound contained between the outer sleeve and the separation sleeve and a second solidifying compound contained between the separation sleeve and the hose.

18. The system of claim 17, wherein the first solidifying compound has a curing rate that is faster than a curing rate of the second solidifying compound.

19. The system of claim 11, wherein the system further comprises a first scaffold and a second scaffold embedded in the solidifying compound between the inner surface of the outer sleeve and the outer surface of the hose.

20. The system of claim 11, wherein the outer sleeve is composed of one or more of polyurethane, polyvinyl chloride (PVC), or polypropylene.
